(19) United States
(12) Patent Application Publication
(10) Pub. No.: US 2016/0037272 A1
(43) Pub. Date: Feb. 4, 2016

(54) MICROPHONE MODULE LATCHING CONFIGURATION FOR A HEARING INSTRUMENT, MICROPHONE MODULE AND HEARING INSTRUMENT

(71) Applicant: SIVANTOS PTE. LTD, SINGAPORE (SG)

(72) Inventors: ANTON GEBERT, KLEINSENDELBACH (DE); ULI GOMMEL, VALENCIA, CA (US); CHUAN FOONG LEE, JOHOR (MY)

(21) Appl. No.: 14/446,582

(22) Filed: Jul. 30, 2014

(51) Int. Cl. H04R 25/00

(52) U.S. Cl. CPC H04R 25/604; H04R 25/65

(57) ABSTRACT

A microphone module latching configuration for fixing a microphone module in a hearing instrument housing is formed at least partly of elastic material and has a planar extended basic shape, upper side, underside and a fixing device on the upper side to be brought into mutual, form-locking engagement with the microphone module, suppressing movement thereof relative to the latching configuration along its planar extent. A positioning device on the underside is brought into mutual, form-locking engagement with a microphone holder of the housing, suppressing movement of the latching configuration along its planar extent relative to the microphone holder, increasing structural freedom of the connection between latching configuration, microphone module and hearing instrument housing. The connection by fixing and positioning devices on the upper or underside eliminates a lateral holder or connection surrounding the microphone module, making the configuration slimmer. A microphone module and hearing instrument are also provided.

### CROSS-REFERENCE TO RELATED APPLICATION

This application claims the priority, under 35 U.S.C. §119, of German Patent Application DE 10 2013 214 916.6, filed Jul. 30, 2013; the prior application is herewith incorporated by reference in its entirety.

### BACKGROUND OF THE INVENTION

### Field of the Invention

The invention relates to a latching configuration for a microphone or a microphone module for a hearing instrument. The invention also relates to a microphone module and a hearing instrument.

Hearing instruments can be constructed, for example, as hearing devices. A hearing device is used to supply a hearing-impaired person with acoustic ambient signals which are processed and amplified for compensation or therapy of respective hearing damage. In principle, the device is formed of one or more input transducers, a signal processing device, an amplification device and an output transducer. The input transducer is generally a sound receiver, e.g. a microphone, and/or an electromagnetic receiver, e.g. an induction coil. The output transducer is generally implemented as an electroacoustic converter, e.g. a miniature loudspeaker, or as an electromechanical converter, e.g. a bone conduction earpiece. It is also referred to as an earpiece or receiver. The output transducer creates output signals which are conveyed to the hearing of the patient and are constructed to create a perception of hearing in the patient. The amplifier is generally integrated into the signal processing device. The hearing device is supplied with power by a battery integrated into the hearing device housing. The main components of a hearing device are generally disposed on a printed circuit board as a circuit carrier or are connected thereto.

Hearing instruments, besides being constructed as hearing devices, can also be constructed as so-called tinnitus maskers. Tinnitus maskers are used for therapy of tinnitus patients. They create acoustic output signals depending on the respective hearing impairment and, in accordance with their principle of operation, also depending on ambient noises, which can contribute to reducing the perception of disruptive tinnitus or other noises in the ear.

Hearing instruments can also be constructed as telephones, cellphones, headsets, headphones, MP3 players or other telecommunications or consumer electronics systems.

The term hearing instrument as used below is intended to be understood as both hearing devices and also tinnitus maskers, comparable devices of that type, as well as telecommunications and consumer electronics systems.

Various basic types of hearing instruments, especially hearing devices, are known. With ITE (In-The-Ear) hearing devices, a housing containing all functional components including a microphone and a receiver, is worn at least partly in the auditory canal. CIC (Completely-in-Canal) hearing devices are similar to the ITE hearing devices but are worn entirely in the auditory canal. With BTE (Behind-The-Ear) hearing devices, a housing with components such as a battery and a signal processing device, is worn behind the ear and a flexible sound tube conducts the acoustic output signals of a receiver from the housing to the auditory canal, where frequently an earpiece is provided on the tube for reliable positioning of the tube end in the auditory canal. RIC-BTE (Receiver-in-Canal Behind-The-Ear) hearing devices are similar to the BTE hearing devices, however the receiver is worn in the auditory canal and instead of a sound tube a flexible receiver tube conducts electrical signals instead of acoustic signals to the receiver which is attached to the front of the receiver tube, mostly in an earpiece used for reliable positioning in the auditory canal. RIC-BTE hearing devices are frequently used as so-called open-fit devices, in which the auditory canal remains open for the passage of sound and air, for reducing a disruptive occlusion effect.

Deep-Fit hearing devices are similar to the CIC hearing devices. However, while CIC hearing devices are generally worn in a further-out (distal) section of the outer auditory canal, deep-fit hearing devices are pushed further in towards the eardrum (proximally) and are worn at least partly in the inner section of the outer auditory canal. The outer section of the auditory canal is a canal lined with skin and connects the ear muscle to the eardrum. In the outer section of the outer auditory canal which directly adjoins the ear muscle, the canal is formed from elastic cartilage. In the inner section of the outer auditory canal the canal is formed from the temporal bone and thus is formed of bone. The course of the auditory canal between the cartilaginous section and the bone section is generally angled in a (second) bend and encloses an angle which differs from person to person. The bony section of the auditory canal, in particular, is comparatively sensitive to pressure and movements. Deep-fit hearing devices are worn at least partly in the sensitive bony section of the auditory canal. Upon insertion into the bony section of the auditory canal they also have to pass the aforesaid bend which, depending on the angle, can be difficult. In addition small diameters and winding forms of the auditory canal can further complicate the insertion.

Cochlea implants and bone-anchored hearing aids (BAHA) are also known in addition to the hearing device types to be worn on or in the ear with an acoustic receiver.

Common to all hearing device types is that they aim to have the smallest possible forms of housing or construction in order to enhance wearing comfort, where necessary to improve implantability and if necessary to reduce visibility of the hearing device for cosmetic reasons. The aim of having the smallest possible structure also applies to most other hearing instruments.

FIG. 1 is a diagrammatic illustration of a previously-known hearing instrument with a directional microphone configuration 13. The hearing instrument has a BTE housing 11 which is equipped with an earhook thread 16 for connecting an earhook. The microphone configuration 13 includes two microphones 14, 15, which are each disposed under a microphone opening of the housing 11. They sit in a substantially rectangular elastic bezel, on which a circular seal is molded. The respective seal serves to acoustically seal the respective microphone input and also to decouple it from the housing with respect to vibrations. The microphones or microphone bezels are each permanently connected to the housing, for example glued or welded or fitted using a form-locking connection. A form-locking connection is one which connects two elements together due to the shape of the elements themselves, as opposed to a force-locking connection, which locks the elements together by force external to the elements.

U.S. Pat. No. 7,151,839 B2 discloses a microphone module for a hearing instrument. The microphone module has a number of microphones which form a directional microphone configuration. It is fastened in the housing by using pins or hooks.

U.S. Patent Application Publication No. US 2010/0208927 A1 likewise discloses a microphone module for a hearing instrument. It is suspended in an elastic mount. The elastic mount is fastened in the housing by using collars or studs, which are disposed on appendages.

### SUMMARY OF THE INVENTION

It is accordingly an object of the invention to provide a microphone module latching configuration for a hearing instrument, a microphone module and a hearing instrument, which overcome the hereinafore-mentioned disadvantages of the heretofore-known devices of this general type and which provide an attachment for a microphone module in a hearing instrument having acoustic-damping or decoupling properties, being space-saving and inexpensive to install.

With the foregoing and other objects in view there is provided, in accordance with the invention, a microphone module latching configuration for fixing a microphone module in a housing of a hearing instrument, wherein the microphone module latching configuration is formed at least partly of elastic material. The microphone module latching configuration has a planar extended basic shape and a fixing device is disposed on an upper side of the microphone module latching configuration, which is able to be brought into engagement with the microphone module in a form-locking connection and is embodied in such a way that a movement of the microphone module relative to the microphone module latching configuration along its planar extent is suppressed. Disposed on an underside of the microphone module latching configuration is a positioning device, which is able to be brought into form-locking mutual engagement with a microphone holder of the housing and is embodied in such a way that a movement of the microphone module latching configuration along its planar extent relative to the microphone holder is suppressed.

In accordance with another advantageous feature of the basic concept of the invention, the fixing device is embodied longitudinally in such a way that, during form-locking mutual engagement, it suppresses a rotation of the microphone module relative to the microphone module latching configuration along its planar extent.

In accordance with a further advantageous feature of the basic concept of the invention, the fixing device includes at least one raised area protruding from the planar extent of the microphone module latching configuration.

In accordance with an added advantageous feature of the basic concept of the invention, the positioning device is embodied longitudinally in such a way that, with a form-locking mutual engagement, a rotation of the microphone module latching configuration along its planar extent relative to the housing is suppressed.

In accordance with an additional advantageous feature of the basic concept of the invention, the positioning device has at least one raised area protruding from the planar extent of the microphone module latching configuration.

In accordance with yet another advantageous feature of the basic concept of the invention, the microphone module latching configuration has a hardness of 20 to 70 Shore.

With the objects of the invention in view, there is also provided a microphone module, which is embodied to be latched by a microphone module latching configuration according to the invention in a housing of a hearing instrument. The microphone module has at least one base side with a planar extent and a fixing receptacle which is disposed on the base side of the microphone module is able to be brought into mutual form-locking engagement with the microphone module latching configuration and is embodied in such a way that a movement of the microphone module relative to the microphone module latching configuration along its planar extent is suppressed.

In accordance with another advantageous feature of the basic concept of the invention, the fixing receptacle is embodied longitudinally in such a way that, with mutual, form-locking engagement, it suppresses a rotation of the microphone module relative to the microphone module latching configuration along its planar extent.

In accordance with a further advantageous feature of the basic concept of the invention, the fixing receptacle has at least one recess in its base side.

With the objects of the invention in view, there is furthermore provided a hearing instrument including a housing, a microphone module embodied according to the invention and a microphone module latching configuration embodied according to the invention. A microphone holder which is disposed in the housing of the hearing instrument has a holder side with the basic planar extent and a positioning receptacle which is embodied on the wall next to the holder side is able to be brought into mutual, form-locking engagement with the microphone module latching configuration and is embodied in such a way that a movement of the microphone module latching configuration along its planar extent relative to the microphone holder will be suppressed.

In accordance with another advantageous feature of the basic concept of the invention, the positioning receptacle is embodied longitudinally in such a way that, during mutual form-locking engagement, it suppresses a rotation of the module latching configuration along its planar extent relative to the microphone holder.

In accordance with a concomitant advantageous feature of the basic concept of the invention, the positioning receptacle has at least one recess in the planar extent.

An advantage of the above-described microphone module latching configuration lies in its greater freedom in the construction of the mutual connection between the microphone module latching configuration, the microphone module and the hearing instrument housing. Due to the mutual connection being made in each case by fixing and positioning devices disposed on the upper side or lower side, a laterally-disposed holder or connection surrounding the microphone module can be dispensed with. This means that the overall configuration is slimmer.

Dispensing with a glued, welded, screwed or other type of fixed mutual connection and instead using a mutual form-locking connection, increases flexibility in production and if necessary maintenance as well. In particular, the form-locking connection can be dismantled at any time without destroying it. The positioning and fixing devices in this case have the effect of latching the microphone module latching configuration in relation to the hearing instrument housing and also latching the microphone module in relation to the microphone module configuration into its planar extent (x-direction and y-direction). A mutual movement in the further spatial direction (z-direction) is not prevented by the hearing instrument housing until the microphone module, pre-mounted on the microphone module latching configuration, is inserted into the housing. For this purpose the hearing instrument housing has an installation position for the pre-mounted module, the height (extent in the z-direction) of which corresponds to the pre-mounted module.

By choosing a suitable hardness and elasticity, the microphone module latching configuration additionally assumes the function of decoupling the module acoustically or with respect to vibrations from the hearing instrument housing. Suitable materials can be silicon polymers or Viton, for example.

The microphone module is connected to the signal processing device of the hearing instrument by using a flexible connection, for example by using a flexible printed conductor track. In this way, a high tolerance with respect to the installation position is achieved. In addition, a mechanical loading of the connection between the signal processing device and the microphone module is achieved.

Other features which are considered as characteristic for the invention are set forth in the appended claims.

Although the invention is illustrated and described herein as embodied in a microphone module latching configuration for a hearing instrument, a microphone module and a hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic, perspective view of a prior art hearing instrument with a directional microphone configuration;

FIG. 2 is a fragmentary, perspective view of a hearing instrument with a microphone module latching configuration and a microphone module according to the invention;

FIG. 3 is a perspective view of a microphone module;

FIG. 4 is an enlarged, cross-sectional view of a hearing instrument with a microphone module latching configuration and a microphone module;

FIG. 5 is a perspective view of a microphone module latching configuration with a microphone module;

FIG. 6 is a perspective view of a microphone module latching configuration;

FIG. 7 is a perspective view of a BTE hearing instrument;

FIG. 8 is a perspective view of an ITE hearing instrument;

FIG. 9 is an exploded, perspective view of a microphone module latching configuration and a microphone module; and

FIG. 10 is an exploded, perspective view of a microphone module latching configuration and a microphone holder.

### DETAILED DESCRIPTION OF THE INVENTION

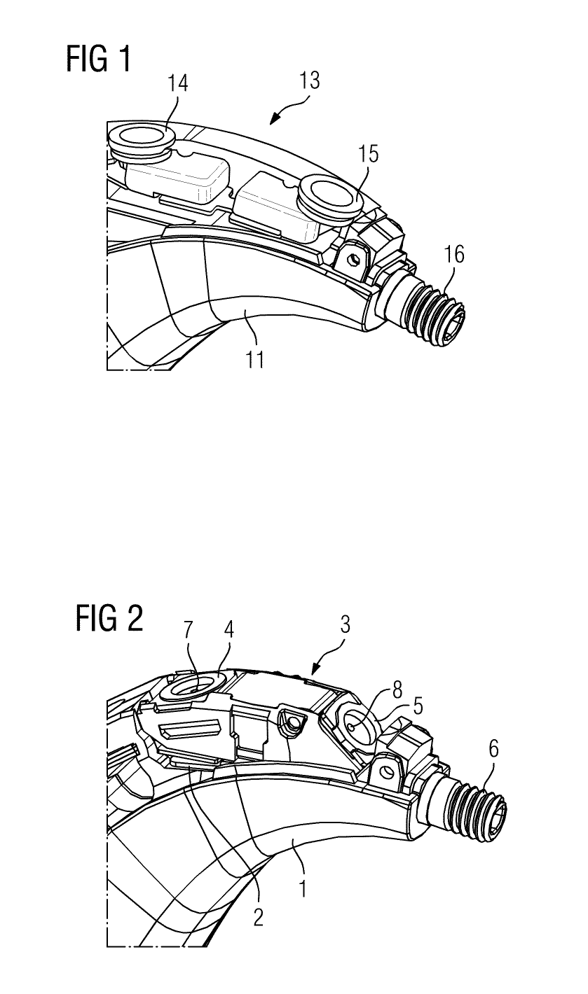

Referring now to the figures of the drawings in detail and first, particularly, to FIG. 1 thereof, there is seen a hearing instrument with a microphone module latching configuration 2 and a microphone module 3 in a perspective view and without an upper housing half. Instead, only a lower half of a housing 1 is shown. The microphone module latching configuration 2 is disposed below the microphone module 3 and only a very small part of it is visible.

The microphone module 3 includes two microphones 7, 8, which are positioned so as to be spaced apart from one another and as such form a directional microphone configuration. A microphone seal 4, 5, which is disposed around a respective microphone opening in each case, forms a soundproof connection with the upper housing half which is not shown in the figure. The front volume of the respective microphone 7, 8 is sealed from the rest of the inside of the housing 1 by the respective microphone seal 4, 5.

A section of the microphone module 3, which is disposed between the microphones 7 and 8, can be used for further components which, however, are not shown in the drawing. In this area a coil antenna is disposed in the microphone module 3, which can preferably serve as a telecoil or wireless antenna for connection to a remote control.

The housing 1 includes further mechanical and electronic components, for example a frame to which the microphone module 3 along with the microphone module latching configuration 2 is attached, as well as a connection for an earhook, which is provided with an earhook thread 6.

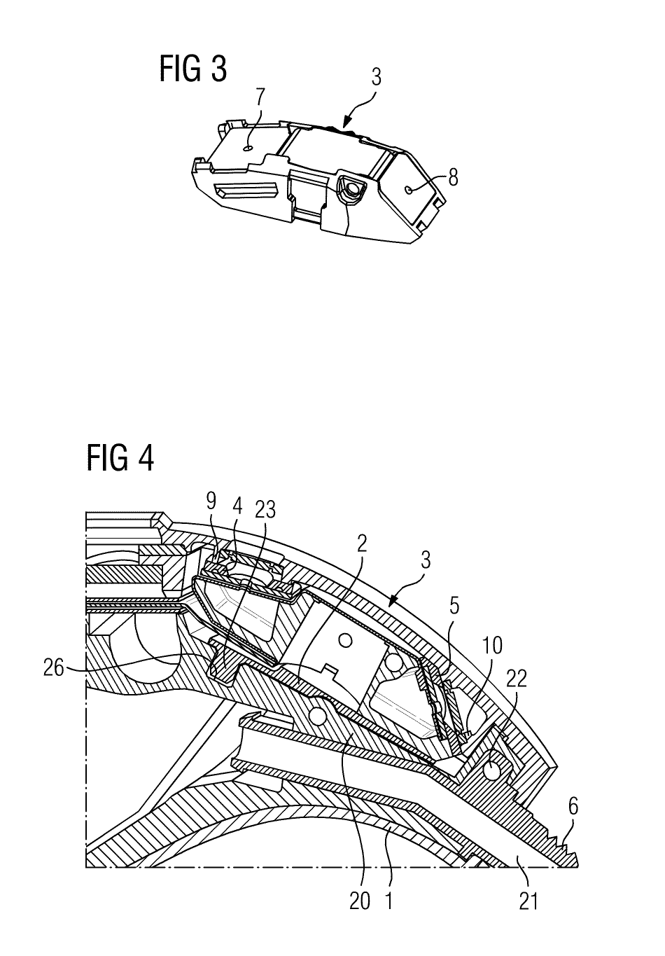

FIG. 3 shows a perspective view of the microphone module 3 alone. The microphones 7, 8 are oriented to fit into the non-illustrated hearing instrument housing above them, in the assembled state. It can be seen that the microphone module 3 has a planar, substantially level base side which is disposed at the bottom in the figure.

FIG. 4 shows a section of the housing 1 similar to that shown previously in a perspective view and a cross-sectional view. The microphone module 3 disposed in the housing 1 is likewise shown in cross-section. The microphones 7, 8 are embodied for illustrative purposes as Mems microphones. The respective microphone seal 4, 5 is disposed above the respective microphone 7, 8. By contrast with the previous figure, the housing 1 is shown with the upper housing half. The upper housing half has a respective sealing collar 9, 10 at a position corresponding to the respective microphone seal 4, 5. The respective sealing collar 9, 10 has the same circumferential shape as the respective microphone seal 4, 5. In the assembled state shown, the respective microphone seal 4, 5 is pushed or pressed onto the respective sealing collar 9, 10. The pressure produces a soundproof connection which, because of the elastic properties of the sealing rings 4, 5, simultaneously forms a decoupling for vibrations. The pressure to be applied to and the elasticity of the microphone seals 4, 5 is preferably selected in this case so that a compression rate of the microphone seals 4, 5 from 30% to 80% is set. The microphone seals can preferably be manufactured from silicon polymer or Viton.

As previously explained, a free space is provided between the microphones 7, 8 in the microphone module 3 which can be used for a coil antenna. However, such a coil antenna is not shown in the figure.

The microphone module 3 is disposed on the microphone module latching configuration 2. The microphone module latching configuration 2 in turn is disposed on a microphone holder 20. The microphone configuration 20 is embodied as a component of the frame which also carries the further electrical and mechanical components disposed in the housing 1.

In order to safely position the microphone module latching configuration 2 on the microphone holder 20 and to fix it against undesired movements relative to the microphone holder 20, a positioning device is provided on the underside of the microphone module latching configuration 2. This positioning device is represented by at least one positioning element or positioners 23. Further positioning elements are not visible in the selected figure. The positioning element or positioning elements 23 are introduced into corresponding positioning receptacles of the microphone holder 20. In this way, slippage of the microphone module latching configuration 2 relative to the microphone holder 20 in the direction of its planar extent is suppressed.

In order to prevent the microphone module 3 from slipping relative to the microphone module latching configuration 2 in the direction of its planar extent, a comparable fixing device is provided therebetween, but is not shown in the diagram however. The microphone module 3 is secured against slippage or against undesired movement of the microphone module 3 at right angles to the plane of the microphone module latching configuration 2 in that it is clamped between the microphone holder 20 and the upper housing half of the housing 1. In this case the microphone module latching configuration 2 exerts pressure from below against the microphone module 3, which in turn is transferred as a compression pressure to the microphone seals 4, 5 and is directed against the housing 1 or the sealing collars 9, 10. In other words the microphone module 3 is clamped between the microphone seals 4, 5 and the microphone latching configuration 2. The microphone latching configuration 2, like the microphone seal 4, 5, is manufactured from elastic material, preferably from a silicon polymer or Viton. This produces an elastic latching of the microphone module 3 in the housing 1, decoupled from vibrations and body noise.

The microphone module 3 is electrically connected, in a manner which is not shown in any greater detail, to a signal processing device of the hearing instrument, for example by a flexible printed conductor track. The signal processing device is mounted, like the earhook connection, on the frame of the hearing instrument. The earhook connection has a sound channel 21 and is equipped with an earhook thread 6. An attachment device 22 is used to mount the earhook connection in the frame having the holder 20.

FIG. 5 shows the microphone module 3 along with the microphone module latching configuration 2 in the reverse orientation in a perspective view. It can be seen that a number of positioning elements or positioners 23 protrude from the flat level basic shape of the microphone module latching configuration 2. The positioning elements 23 together form the positioning device and are clearly constructed so that a movement or rotation of the microphone module latching configuration 2 in the plane of its planar extent is suppressed, as soon as the positioning elements 23 are introduced into corresponding positioning receptacles of the frame of the hearing instrument.

The microphone module latching configuration 2 has fixing elements 25 on the side opposite the positioning elements 23, which form an opposing fixing device. The fixing elements 25 are received by corresponding fixing receptacles 25 in the microphone module 3. The fixing receptacles 25 are indicated by dashed lines. The fixing elements serve to suppress a rotation or slippage of the microphone module 3 in relation to the microphone module latching configuration 2 in the direction of its planar, level surface.

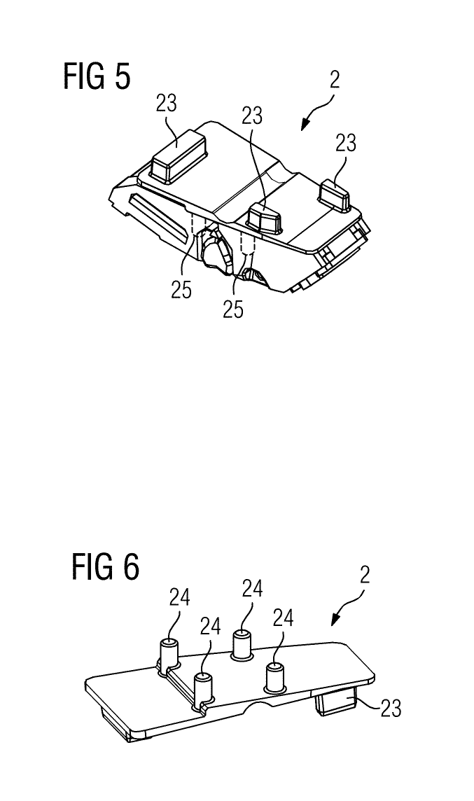

FIG. 6 shows the microphone module latching configuration 2 alone in a perspective view. The fixing elements 24, which are shown on the upper side of the microphone module latching configuration 2, together form the fixing device for fixing a microphone module, which is not shown in the figure, to the microphone module latching configuration. On the opposite lower side a positioning element 23 of the positioning device can be seen, which is used for the positioning of the microphone module latching configuration 2 in the hearing instrument housing.

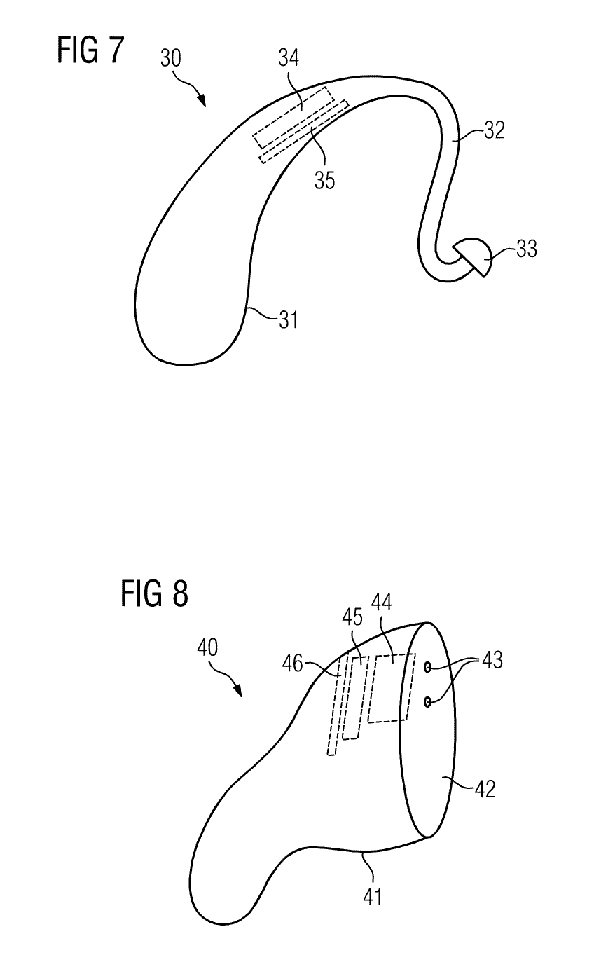

FIG. 7 shows a diagrammatic view of a BTE hearing instrument 30. The BTE hearing instrument 30 includes a housing 31, which is connected through a tube 32 to an earpiece 33 to be positioned in the auditory canal. In addition to further elements not shown in the figure, a microphone module latching configuration 35, indicated by dashed lines, as well as a microphone module 34 latched in the housing by the configuration, are indicated in the housing 31. The microphone module latching configuration 35 serves, in the manner previously explained, to latch the microphone module 34 in the housing 31.

FIG. 8 is a diagrammatic illustration of an ITE hearing instrument 40. The ITE hearing instrument 40 has a housing 41 as well as a faceplate 42 closing off the housing 42. Microphone openings 43, which are spaced apart from one another, are disposed in the faceplate 42. The microphone openings 43 are used for a directional microphone configuration lying below them.

A microphone module 44, which is indicated by a dashed outline, is disposed in the housing 41 below the microphone openings 43. The microphone module 44 is latched in the housing 41 by a microphone module latching configuration 45 in the manner explained previously. To this end the microphone module latching configuration 45 is positioned in the likewise previously explained manner on a microphone holder 46.

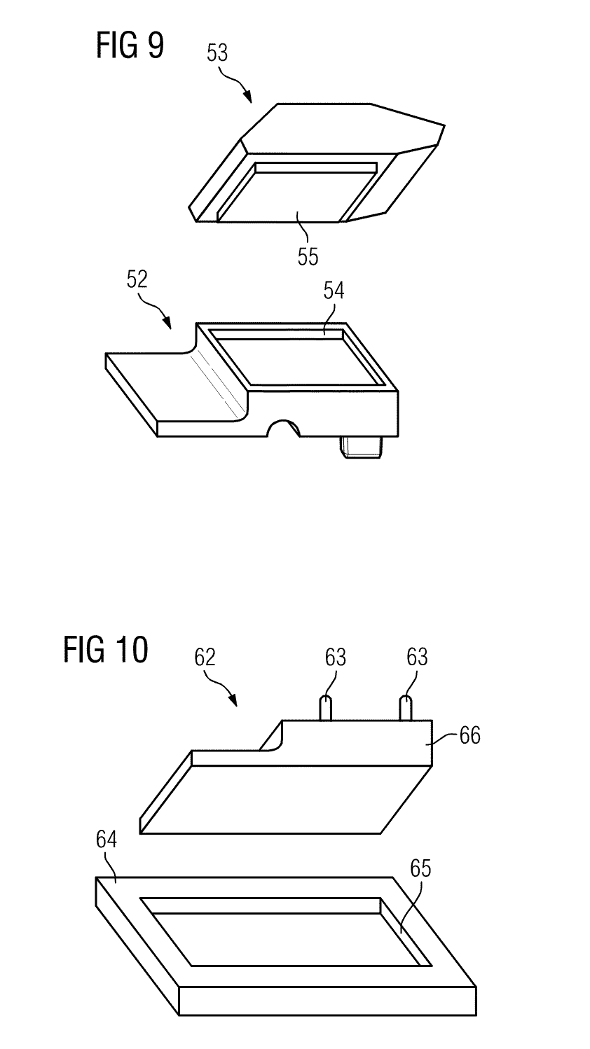

FIG. 9 shows a microphone module latching configuration 52 along with a microphone module 53 in another embodiment. The fixing device for fixing the microphone module 53 to the microphone module latching configuration 52 is formed by a fixing receptacle 55, which is embodied as a rectangular raised section on the lower side of the microphone module 53. This fixing receptacle 55 can be inserted to form a precise fit into a fixing element 54 of the microphone module latching configuration 52 embodied as a corresponding frame. It is clear that the microphone module 53 is secured against slippage relative to the microphone module latching configuration 52 as soon as the fixing device formed of the fixing receptacle 55 and the fixing element 54 is brought into mutual engagement.

FIG. 10 shows a further form of an embodiment of a microphone latching configuration 62 and a microphone holder 64. The microphone holder 64 has a positioning receptacle 65 embodied as a frame 65. This frame is shaped in accordance with the planar basic shape of the microphone module latching configuration 62, so that the latter can be inserted in a precise fit into the positioning receptacle 65. It can be seen that the microphone module latching configuration 62 is secured against slippage and rotation as soon as it is brought into mutual engagement with the positioning receptacle 65. In this sense, the base body of the microphone module latching configuration 62 or the outer edge running around the configuration forms a positioning element 66 which, with the positioning receptacle 65, forms the positioning device. Fixing elements 63, which are used for fixing a microphone module which is not shown in the figure to the microphone module latching configuration 62, can be seen on the upper side of the microphone module latching configuration 62.

1. A microphone module latching configuration for fixing a microphone module in a housing of a hearing instrument, the microphone module latching configuration comprising:
an elastic material forming at least part of the microphone module latching configuration;
a basic shape having a planar extent, an upper side and an underside;
a fixing device disposed on said upper side, configured to be brought into mutual, form-locking engagement with the microphone module and configured to suppress a movement of the microphone module relative to the microphone module latching configuration along its planar extent; and
a positioning device disposed on said underside, configured to be brought into form-locking mutual engagement with a microphone holder of the housing and configured to suppress a movement of the microphone module latching configuration along its planar extent relative to the microphone holder.

2. The microphone module latching configuration according to claim 1, wherein said fixing device has a longitudinal structure configured to suppress a rotation of the microphone module relative to the microphone module latching configuration along said planar extent, during mutual form-locking engagement.

3. The microphone module latching configuration according to claim 1, wherein said fixing device includes at least one raised area projecting from said planar extent.

4. The microphone module latching configuration according to claim 1, wherein said positioning device has a longitudinal structure configured to suppress a rotation of the microphone module latching configuration along said planar extent in relation to the housing, during mutual, form-locking engagement.

5. The microphone module latching configuration according to claim 4, wherein said positioning device includes at least one raised area projecting from said planar extent.

6. The microphone module latching configuration according to claim 1, wherein the microphone module latching configuration has a Shore hardness of 20 to 70.

7. A microphone module to be latched by a microphone module latching configuration in a housing of a hearing instrument, the microphone module comprising:
at least one base side with a planar extent; and
a fixing receptacle disposed on said base side, configured to be brought into mutual, form-locking engagement with the microphone module latching configuration according to claim 1 and configured to suppress a movement of the microphone module relative to the microphone module latching configuration along said planar extent.

8. The microphone module according to claim 7, wherein said fixing receptacle has a longitudinal structure configured to suppress a rotation of the microphone module relative to the microphone module latching configuration along said planar extent, during a mutual, form-locking engagement.

9. The microphone module according to claim 7, wherein said fixing receptacle has at least one recess in said base side.

10. A hearing instrument, comprising:
a housing;
a microphone module according to claim 7;
a microphone module latching configuration according to claim 1;
a microphone holder disposed in said housing, said microphone holder including a holder side having a basic shape with a planar extent; and
a positioning receptacle disposed on or at said holder side and configured to be brought into mutual, form-locking engagement with said microphone module latching configuration to suppress a movement of said microphone module latching configuration along its planar extent relative to said microphone holder.

11. The hearing instrument according to claim 10, wherein said positioning receptacle has a longitudinal structure configured to suppress a rotation of said microphone module latching configuration along its planar extent relative to said microphone holder, during a mutual, form-locking engagement.

12. The hearing instrument according to claim 10, wherein said positioning receptacle has at least one recess in said planar extent.
